(19) United States
(12) Patent Application Publication
(10) Pub. No.: US 2007/0105524 A1
(43) Pub. Date: May 10, 2007

(54) Remotely powered wireless microphone

(76) Inventors: Scott F. Fullam, Palo Alto, CA (US); Brian L. Hinman, Los Gatos, CA (US)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 11/268,976

(22) Filed: Nov. 7, 2005

(51) Int. Cl. H04B 1/10; H04B 1/16

(52) U.S. Cl. 455/343.1; 455/299; 455/572

(57) ABSTRACT

Various methods, apparatuses, and systems in which a remotely powered wireless microphone are described. The remotely powered wireless microphone circuit includes a resonant circuit tuned to a transmit frequency of a receiver station. The resonant circuit captures signal bursts from the receiver station. The resonant circuit includes a capacitive microphone element to modulate a resulting ringing of the circuit upon being energized by the signal bursts. The wireless microphone circuit also includes a transmitter circuit to transmit the modulated signal.

### FIELD

Embodiments of the invention generally relate to a wireless microphone. More particularly, an aspect of an embodiment of the invention relates to a remotely powered wireless microphone.

### BACKGROUND

Wireless microphones generally require a power source to operate. Typically, the power source is a battery. The battery limits how small and light weight the wireless microphone can be, and also needs to be changed or recharged on a regular basis to operate. Batteries are also prone to corrosion.

One use of wireless microphones is in remote controls. Remote controls that include a wireless microphone can consume a great deal of power, particularly for operating the microphone circuit. A short battery life means that the batteries for the remote control are often discharged, often requiring a user of the remote control to have to change the batteries in the remote control very often.

### SUMMARY

A remotely powered wireless microphone is described. In one embodiment of the present invention, the remotely powered wireless microphone circuit includes a resonant circuit tuned to a transmit frequency of a receiver station. The resonant circuit captures signal bursts from the receiver station. The resonant circuit includes a capacitive microphone element to modulate the captured signal. The wireless microphone circuit also includes a transmitter circuit to transmit the modulated signal.

In another embodiment, a communication system is described. The communication system includes a transmitter to transmit a re-occurring series of signal bursts at a first frequency. The signal bursts are designed to include very high peak power content and to be very short in duration. The communication system includes a wireless microphone circuit to capture the transmitted signal bursts, to modulate the captured signal, and to transmit the modulated signal. The wireless microphone circuit operates without using any locally pre-stored energy. The communication system also includes a receiver to receive the modulated signal.

Other aspects and embodiments of the invention will be apparent from the accompanying figures and from the detailed description that follows.

### BRIEF DESCRIPTION OF THE DRAWINGS

The drawings refer to embodiments of the invention in which:

FIG. 1 is an embodiment of a communication system 100 according to one embodiment of the invention;

FIG. 2 is an embodiment of a communication system 201 according to one embodiment of the invention;

FIG. 3 illustrates a schematic diagram of an embodiment of a wireless microphone circuit 210 utilizing no locally pre-stored power;

FIG. 4 illustrates a schematic diagram of an embodiment of a wireless microphone circuit 300 utilizing no locally pre-stored power;

FIG. 5 illustrates a schematic diagram of an embodiment of a wireless microphone circuit 400 utilizing no locally pre-stored power;

FIG. 6 illustrates a diode output waveform for the circuit illustrated in FIG. 5;

FIG. 7 illustrates a schematic diagram of an embodiment of a wireless microphone circuit 401 utilizing no locally pre-stored power;

FIG. 8 illustrates a diode output waveform for the circuit illustrated in FIG. 7;

FIG. 9 illustrates a schematic diagram of an embodiment of a wireless microphone circuit 500 utilizing no locally pre-stored power;

FIG. 10 illustrates a schematic diagram of an embodiment of a wireless microphone circuit 501 utilizing no locally pre-stored power;

FIG. 11 illustrates a schematic diagram of an embodiment of a wireless microphone circuit 600 utilizing no locally pre-stored power;

FIGS. 12A-C illustrate two series as an illustration of the shaping of the receiver output waveform according to certain embodiments of the invention;

FIG. 13 illustrates spikes of transmitter energy in time and a delayed spike received by the receiver station; and

FIGS. 14A-B illustrate an embodiment of an output waveform for the tank circuit.

While the invention is subject to various modifications and alternative forms, specific embodiments thereof have been shown by way of example in the drawings and will herein be described in detail. The invention should be understood to not be limited to the particular forms disclosed, but on the contrary, the intention is to cover all modifications, equivalents, and alternatives falling within the spirit and scope of the invention.

### DETAILED DISCUSSION

In the following description, numerous specific details are set forth, such as examples of specific signals, named components, connections, example voltages, etc., in order to provide a thorough understanding of the present invention. It will be apparent, however, to one of ordinary skill in the art that the present invention may be practiced without these specific details. In other instances, well known components or methods have not been described in detail but rather in a block diagram in order to avoid unnecessarily obscuring the present invention. Specific numeric reference should not be interpreted as a literal sequential order but rather interpreted that the first leg is different than a second leg. Thus, the specific details set forth are merely exemplary. The specific details may be varied from and still be contemplated to be within the spirit and scope of the present invention. In general, a remotely powered wireless microphone is described. In one embodiment of the present invention, the remotely powered wireless microphone circuit includes a resonant circuit tuned to a transmit frequency of a receiver station. The resonant circuit captures signal bursts from the receiver station. These signal bursts are designed to have very high peak power content and carry no information. The resonant circuit includes a capacitive microphone element to modulate the captured signal. The wireless microphone circuit includes a transmitter circuit to transmit the modulated signal at a frequency which may be the same as the transmit frequency of the receiver station or may be different.

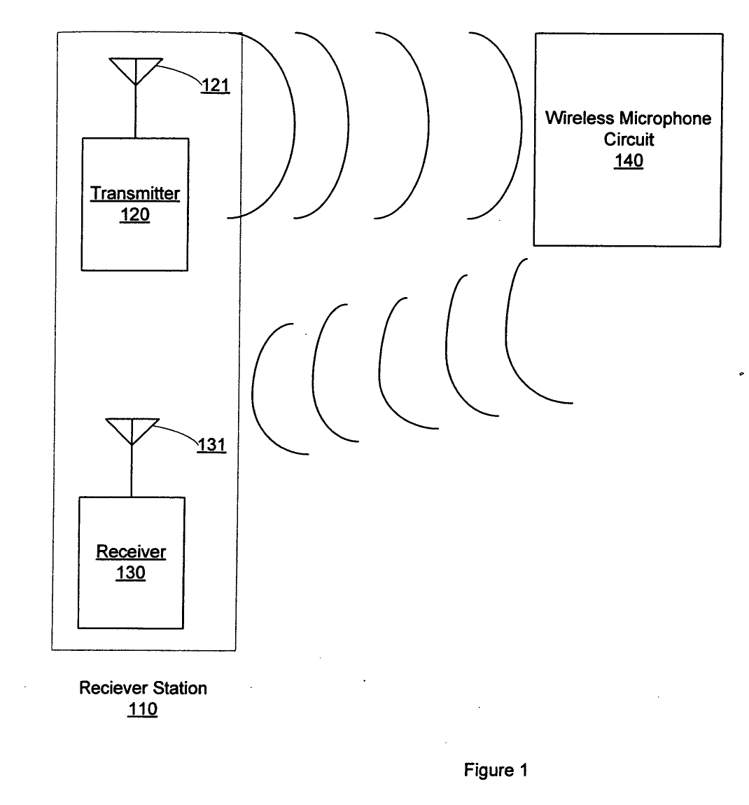

FIG. 1 illustrates a block diagram of an embodiment of a radio communication system 100 including a remotely powered wireless microphone circuit. The function of a radio or wireless system is to send information in the form of a radio signal. In this discussion, the information is assumed to be an audio signal, but of course, video, data, or control signals can be sent via radio waves. In each case, the information is converted to a radio signal, transmitted, received, and converted back to its original form. The initial conversion consists of using the original information to create a radio signal by modulating a basic radio wave. In the final conversion, a complementary technique is used to demodulate the radio signal to recover the original information.

A receiver station 110 sends out a re-occurring series of high-energy signal bursts carrying no information at a transmit frequency using a transmitter 120. The bursts are designed to include very high peak power content and be very short in duration to comply with federal regulations.

In certain embodiments, a carrier signal at 915 MHz can be evenly spread over a band of interest (e.g., 902 MHz to 928 MHz) by mixing a sinusoidal carrier with a spreading function such as sin(y)/Y. The resulting signal can contain up to 200 times more energy than a single carrier signal is allowed.

The resulting signal complies with FCC regulations. For instance, FCC Sec. 15.249, which covers operation within the bands 902-928 MHz, 2400-2483.5 MHz, 5725-5875 MHZ, and 24.0-24.25 GHz, provides that a radiator operating within the frequency band 902-928 MHz may have a fundamental field strength of up to 50 millivolts/meter. Further, FCC Sec. 15.35, which covers measurement detector functions and bandwidths, provides that on any frequency or frequencies below or equal to 1000 MHz, the conducted and radiated emission limits are based on measuring equipment employing a CISPR quasi-peak detector function and related measurement bandwidths. Further, CISPR document number 16-1-1 section 4.2 specifies the characteristics for a quasi-peak detector for 30 MHz to 1000 MHz. Specifically, the bandwidth at the −6 dB points is 120 kHz, the detector electrical charge time constant is 1 millisecond, the detector electrical discharge time constant is 550 milliseconds, and mechanical time constant of critically damped indicating instrument is 100 milliseconds.

In one embodiment, the envelope of the pulsed signal is a carrier sin(kx-wt) mixed with a sin(y)/y band limiting function, where k is the angular wave number of the sinusoid and is equal to the value of 2 π/λ, λ is the wavelength of the sinusoid and y is the frequency of the band limit. The wide signal generated by spreading a single carrier signal (e.g., at 915 MHz) over a wide band (e.g., 902 MHz to 928 MHz) by mixing a sinusoidal carrier with a spreading function such as sin(y)/y when measured by the CISPR quasi-peak detector will only register energy in a 120 kHz piece, approximately 1/200th, of the overall 902-928 MHz spectrum. This method therefore allows about 200 times more energy to be transmitted in the 902-928 MHz band than a single carrier.

Accordingly, the carrier or signal frequency is 915 Mhz (the center of the 902-928 Mhz band). The duration of the pulse is defined by the envelope of the band limiting filter, such as sin(y)/y. Accordingly, the duration of the energy burst would be 115.5 nsec since a reasonable approximation to the sin(y)/y function has a width of 2×1/(2×26 MHz)×3, where the duration of the main lobe of the function is 26 MHz.

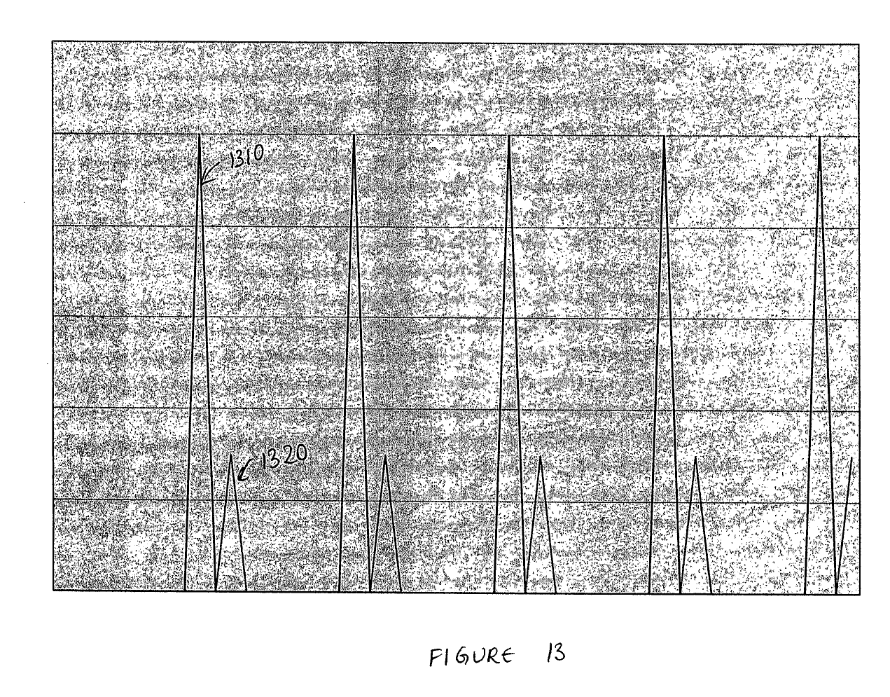

FIGS. 12A-C illustrate two series as an illustration of the shaping of the output waveform. An example of the sin(y)/Y signal 1210 is illustrated in FIG. 12A. An example of the actual waveform sent by receiver station is illustrated in FIG. 12B as waveform 1220. FIG. 12C illustrates waveform 1220 being limited by sin(y)/Y signal 1210.

The radio signal bursts are radiated through an antenna 121 into free space and out to the wireless microphone circuit 140, where they are picked up. In one embodiment, the transmitter 120 is a radio frequency (RF) or infra red (IR) transmitter or a transceiver.

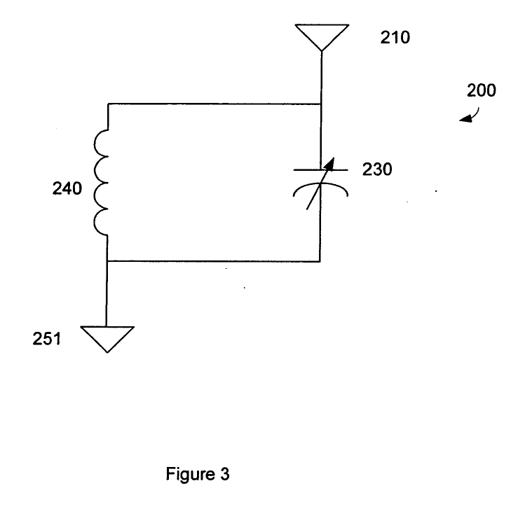

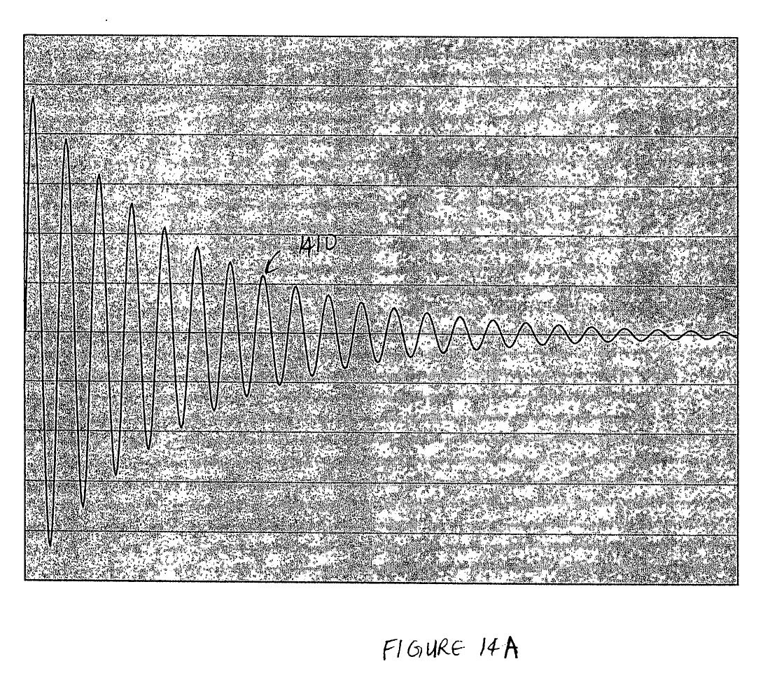

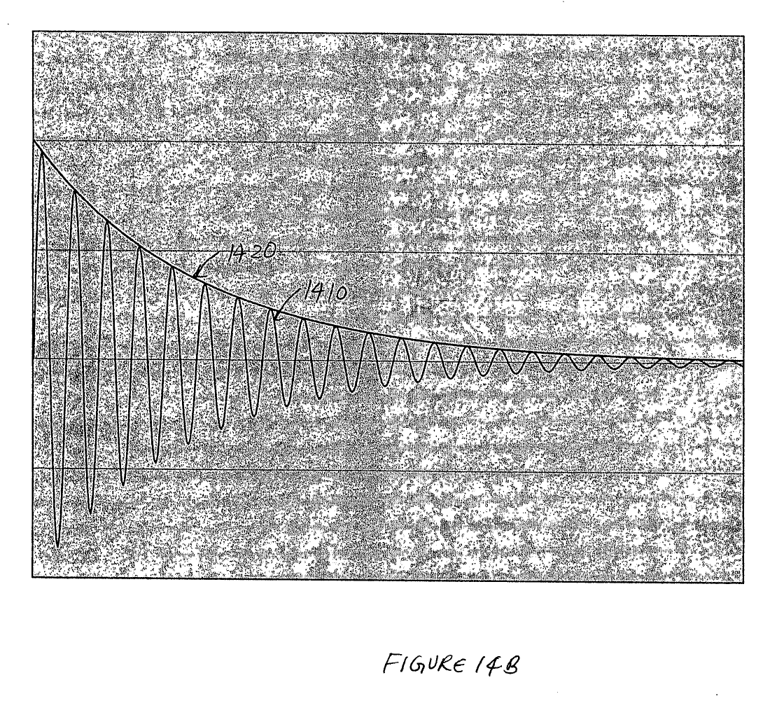

Referring again to FIG. 1, according to certain embodiments of the invention, the wireless microphone circuit 140 includes a resonant circuit and a re-transmitter circuit. The resonant circuit is tuned to the burst transmit frequency of the receiver station 110. In the embodiment shown in FIG. 1, the burst transmit frequency of the receiver station 110 is, for example, 915 MHz. The receiver station sends out narrow pulses of RF energy, resulting in a high-Q ringing of the resonant circuit, re-radiating back to the receiver station 100. The resonant circuit is energized by the incoming signal and modulates the resulting ringing of the circuit that is re-radiated by using a re-transmitter circuit. In one embodiment, the resulting ringing of the circuit is modulated by a change in capacitance of a capacitive microphone element. The capacitance of the microphone element varies as a function of sound pressure within the proximity of the microphone. The re-transmitter circuit re-transmits the modulated signal. The receiver station 110 is listening for an accurate measure of the ringing frequency during the quiet time after it sends out the narrow pulse of RF energy. By measuring the frequency between a pulse sent and a pulse received, the receiver station 110 forms a sampled FM audio signal. The wireless microphone circuit 140 is described in greater detail below with reference to FIGS. 3-11. FIG. 13 illustrates spikes 1310 of transmitter energy in time and a delayed spike 1320 received by the receiver station 110 that represents the echo of the wireless microphone circuit, according to certain embodiments of the invention. There is typically a time delay between an excitation pulse 1310 and its response 1320. For instance, when the wireless microphone circuit is located three meters away from the receiver station 110, the time delay is about 20 nanoseconds. FIG. 14A illustrates an embodiment of an output waveform 1410 for the tank circuit. As shown, output waveform 1410 represents a damped sine wave response for the tank circuit. FIG. 14B illustrates the output waveform 1410 and a waveform 1420 representing the envelope of the decaying output response of the tank circuit.

Referring again to FIG. 1, a receiving circuit 130 at receiver station 110 picks up the retransmitted signal with the audio modulation using antenna 131 and demodulates it. In one embodiment, the receiving circuit 130 is an audio frequency modulated (FM) receiver. In this way, communication system 100 allows for reception of a high quality voice signal while using a wireless microphone circuit that uses no locally pre-stored power. Further, because each receiver station 110 and microphone circuit 140 is tuned to a specific frequency, multiple device pairs may operate in close proximity.

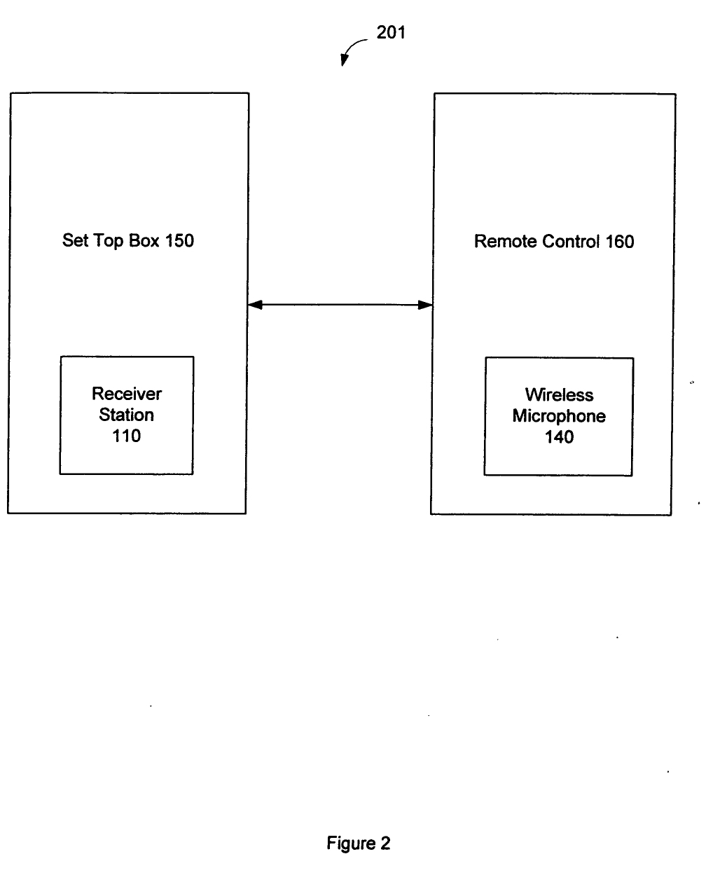

In one embodiment, the wireless microphone circuit 140 may be implemented in a remote control 160 that interacts with a set top box 150 and the receiver station 110 may be implemented in the set top box 150, as illustrated in FIG. 2. Accordingly, the receiver station 110 in the set top box 150 sends out a re-occurring series of high-energy signal bursts carrying no information at a transmit frequency to the remote control 160. The wireless microphone circuit 140 captures the transmitted signal and modulates the signal. The wireless microphone circuit 140 transmits the modulated signal to the set top box 150, where it is received by the receiver station 110. The receiver station 110 demodulates the received signal. Accordingly, remote control 160 transmits radio signals to set top box 150.

FIG. 3 illustrates a schematic diagram of an embodiment of a wireless microphone circuit 200 utilizing no locally pre-stored power. Antenna 210 captures the radio signal transmitted by the transmitter 120. The wireless microphone circuit 200 is both a resonant circuit and a re-transmitter circuit. The resonant circuit is formed by an LC circuit formed using inductance 240 and capacitance 230 and is tuned to the burst transmit frequency of the receiver station 110. The resonant circuit modulates the resulting ringing of the circuit upon being energized and connects a resulting signal to a re-transmitter circuit 250. In one embodiment, the incoming captured signal is modulated by a change in capacitance of a microphone element 230. The capacitance of the microphone element 230 varies as a function of sound pressure within the proximity of the microphone 230. In circuit 200, the re-transmitter circuit is a transmitter antenna 251, which re-transmits the modulated signal.

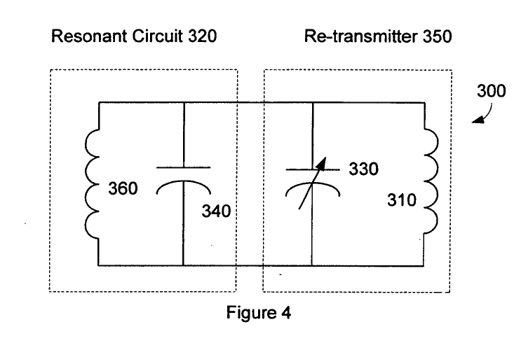

FIG. 4 illustrates a schematic diagram of an embodiment of a wireless microphone circuit 300 utilizing no locally pre-stored power. The wireless microphone circuit 300 includes a resonant circuit 320 and a re-transmitter circuit 350. The resonant circuit 320 is an LC circuit formed using inductance 360 and capacitance 340 and is tuned to the burst transmit frequency of the receiver station 110. The resonant circuit 320 captures the radio signal transmitted by the transmitter 130. The resonant circuit 320 modulates the resulting ringing of the circuit upon being energized and connects a resulting signal to a re-transmitter circuit 350. In the embodiment shown in FIG. 4, re-transmitter circuit 350 is a resonant circuit formed by inductor 310 and capacitor 330. The incoming captured signal is modulated by altering the resonant frequency of the re-transmitter circuit 350. The re-transmitter circuit 350 re-transmits the modulated signal.

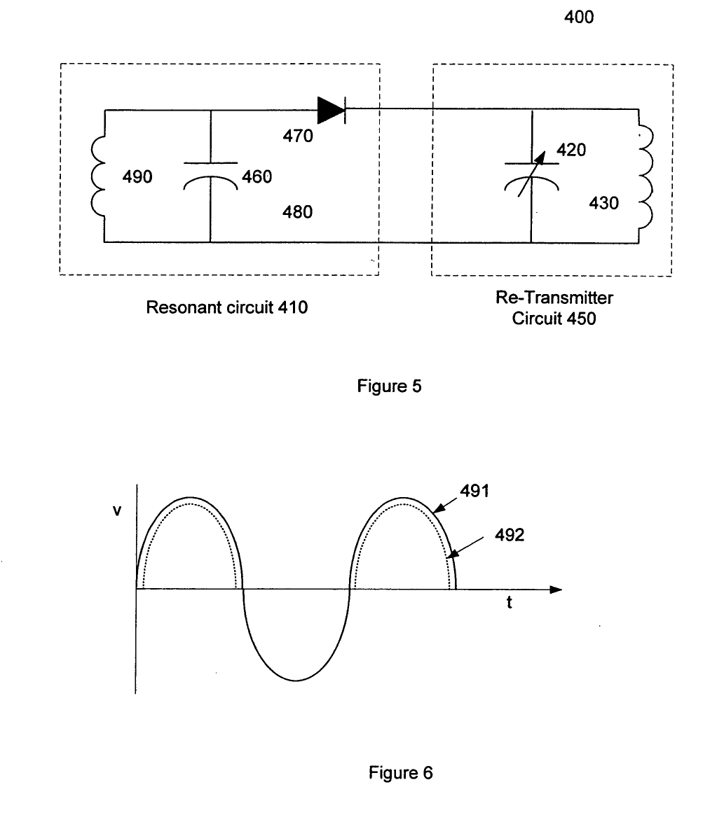

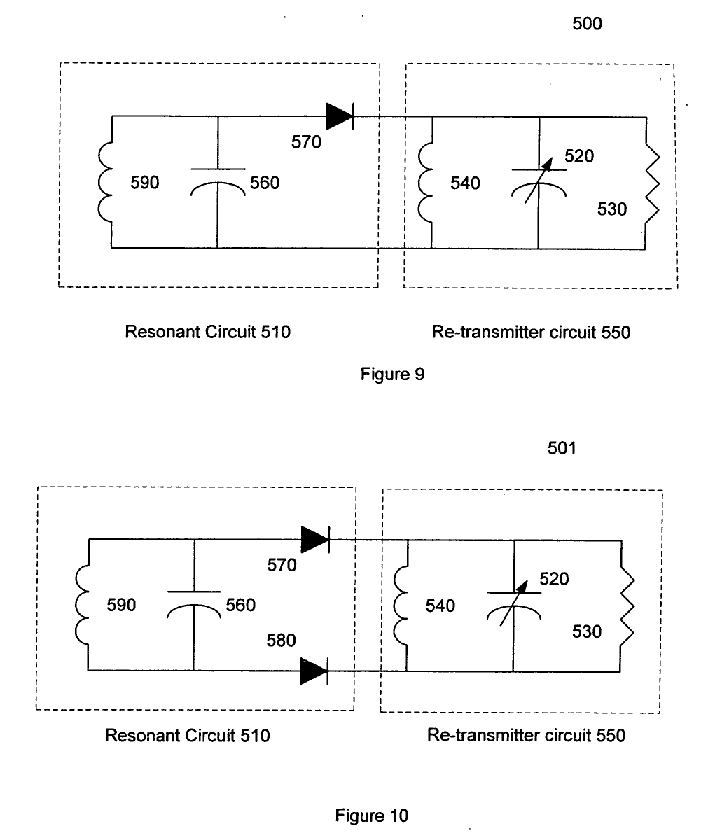

FIGS. 5 and 7 illustrate a schematic diagram of an embodiment of wireless microphone circuits 400 and 401 respectively utilizing no locally pre-stored power. The wireless microphone circuits 400 and 401 utilize non-linear elements to improve the strength of signal transmitted and thus, the quality of the signal detected, at receiver 130. The wireless microphone circuit 400 includes a resonant circuit 410 and a re-transmitter circuit 440. The resonant circuit 410 captures the radio signal transmitted by the transmitter 120. The resonant circuit 410 is an LC circuit formed using inductance 490 and capacitance 460. The resonant circuit 410 is tuned to the burst transmit frequency of the receiver station 110. The resonant circuit 410 modulates the resulting ringing of the circuit upon being energized and connects a resulting signal to the re-transmitter circuit 450. In one embodiment, the incoming captured signal is modulated by a change in capacitance of the microphone element 490. The capacitance of the microphone element 490 varies as a function of sound pressure within the proximity of the microphone 230.

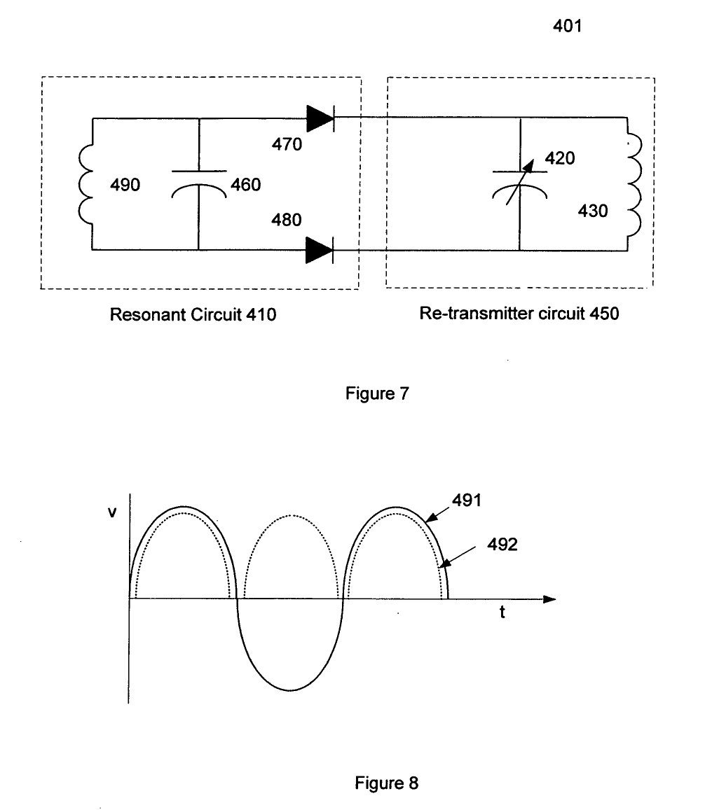

In the circuit 400 shown in FIG. 5, the re-transmitter circuit 450 includes a single diode 470, which operates as a half wave rectifier to rectify the modulated signal. Accordingly, if the modulated signal is in the form of a sine wave 491, the output waveform at the diode and thus, the signal transmitted by re-transmitter circuit 450, is simply either the positive or the negative half of the sinusoid 492, as shown in FIG. 6. The second resonant circuit formed by capacitor 460 and inductor 490 transmits the output waveform.

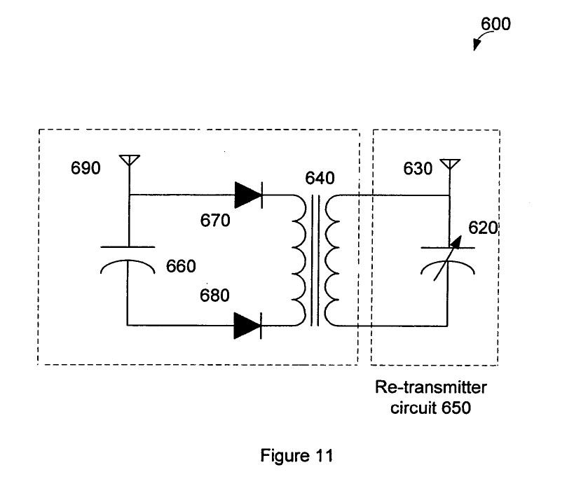

In the circuit 401 shown in FIG. 7, the re-transmitter circuit 440 includes two diodes 470 and 480 that operate as a full wave rectifier to rectify the modulated signal. Accordingly, if the modulated signal is in the form of a sine wave 491, the output waveform at the diode and thus, the signal transmitted by re-transmitter circuit 450, is the waveform 492, as shown in FIG. 8. The diodes 470 and 480 result in a signal emanating at a second harmonic at double the frequency of the captured signal. Thus, the signal input to a second resonant circuit 410 formed by capacitor 460 and inductor 490 has a frequency of twice the burst transmit frequency. The second resonant circuit formed by capacitor 420 and inductor 430 transmits the second harmonic.

In certain embodiments of the invention, a battery or other energy source can be used to bias the diodes 470 and 480, to account for non-ideal diode operation. In one embodiment, the bias current can be very low in order to preserve a long battery life.

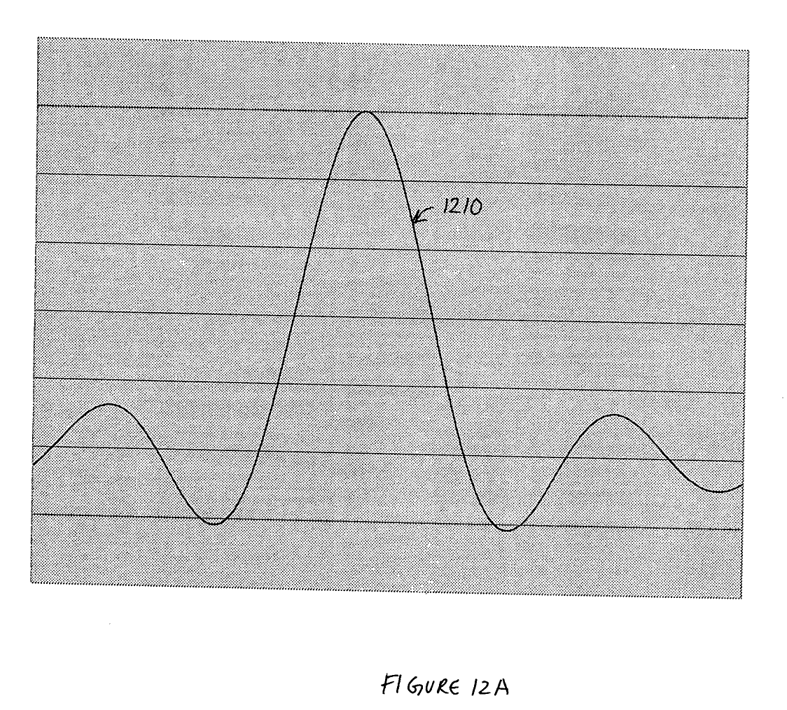

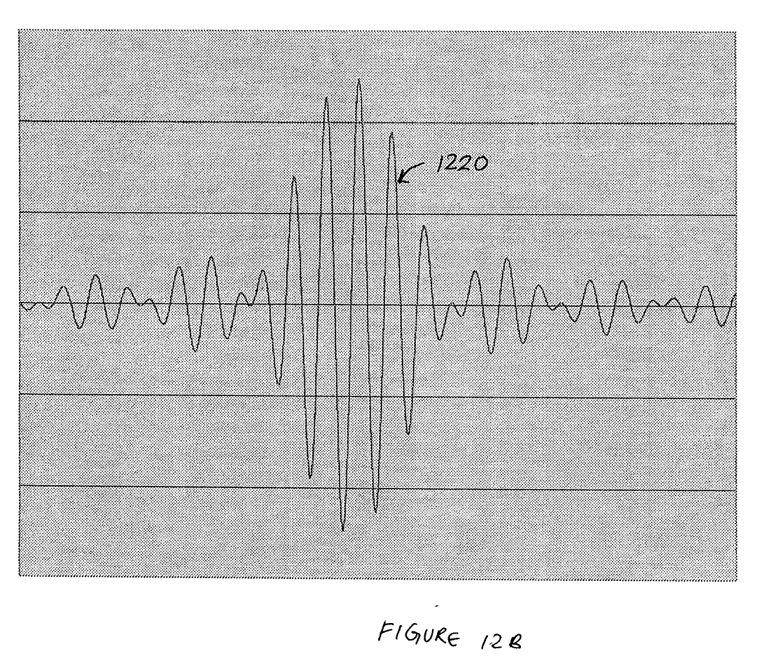

FIGS. 9 and 10 illustrate schematic diagrams of certain embodiments of wireless microphone circuits 500 and 501 respectively utilizing no locally pre-stored power. The wireless microphone circuit 500 utilizes non-linear elements to improve the quality of the signal detected at receiver 130. Wireless microphone circuits 500 and 501 are different from wireless microphone circuits 400 and 401 respectively shown in FIGS. 5 and 7 respectively in that the re-transmitter circuit 550 includes a resistor 530. Resistor 530 represents the value of the antenna load.

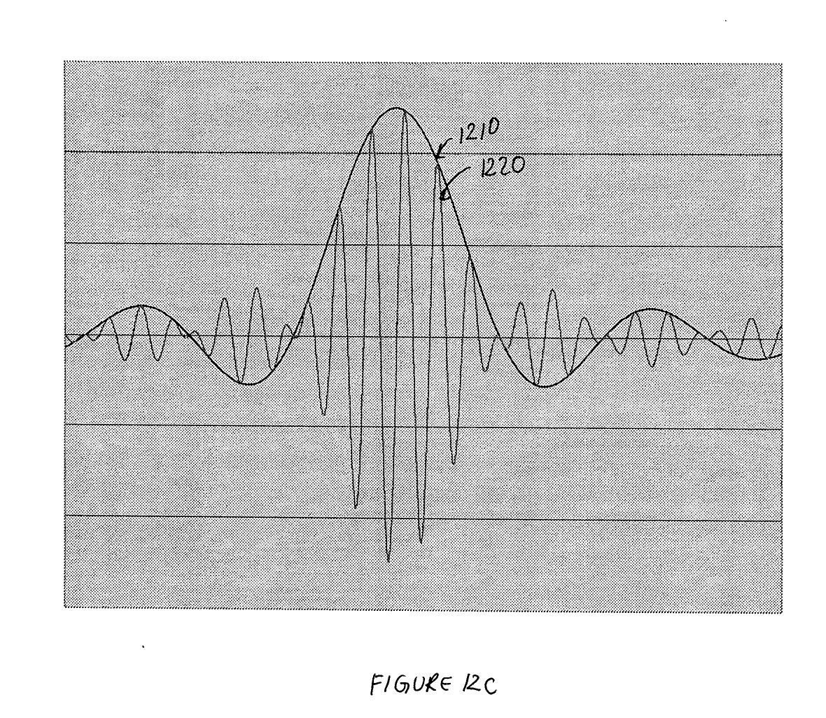

FIG. 11 illustrates a schematic diagram of an embodiment of a wireless microphone circuit 600 utilizing no locally pre-stored power. The wireless microphone circuit 600 utilizes non-linear elements to improve the quality of the signal detected at receiver 130. The wireless microphone circuit 600 includes a condenser microphone 620 and a transformer 640. An antenna 690 captures the radio signal transmitted by the transmitter 120. The resonant circuit condenser microphone 660 modulates the resulting ringing of the circuit upon being energized by a change in capacitance of the microphone element 660. The capacitance of the microphone element 660 varies as a function of sound pressure within the proximity of the microphone 660. The microphone 660 connects a resulting signal to a re-transmitter circuit 650.

The circuit 600 includes two diodes 670 and 680, which operate as a full wave rectifier to rectify the modulated signal. The diodes 670 and 680 result in a signal emanating at a second harmonic at double the frequency of the captured signal. A step up transformer 640 is used to generate a higher voltage to drive the diodes 670 and 680. Most non-linear circuit elements require a bias threshold voltage to begin operating. The step up transformer 640 can provide this higher voltage to allow more efficient circuit operation. The second harmonic is transmitted to receiver 110 via antenna 630.

While some specific embodiments of the invention have been shown the invention is not to be limited to these embodiments. Information other than audio may also be transmitted from the remotely powered wireless microphone circuit to the receiver station using the same method. Temperature, pressure, humidity, and switch open/close information may also be transferred. In each case, the capacitive or inductive element of the resonant circuit may be substituted with an element that changes value when exposed to changing temperature, pressure, humidity, and switch open/close information. The transmitted and received signals may be complimentary differential voltage signals, voltage signals made with respect to a common ground, or other similar voltage signal. The invention is to be understood as not limited by the specific embodiments described herein, but only by scope of the appended claims.

What is claimed is:

1. A wireless microphone circuit, comprising:
a resonant circuit tuned to a transmit frequency, the resonant circuit to capture and modulate signal bursts at the first transmit frequency; and
a re-transmitter circuit to transmit the modulated signal, wherein the wireless circuit receives energy needed to operate the resonant circuit solely via the captured signal bursts independent of a locally pre-stored power supply.

2. The circuit recited in claim 1, wherein the resonant circuit comprises a capacitive microphone element to modulate the captured signal.

3. The circuit of claim 1, wherein the transmitter circuit comprises at least one non-linear component to create a second harmonic of the modulated signal.

4. The circuit of claim 2, wherein the capacitive microphone element modulates the captured signal through a change in capacitance of the microphone element.

5. The circuit of claim 2, wherein the capacitive microphone element modulates the captured signal by altering the resonant frequency of the resonant circuit.

6. The circuit of claim 3, wherein the transmitter circuit comprises two diodes to form a full-wave rectifier circuit.

7. The circuit of claim 6, further comprising a battery source to forward bias the diodes.

8. The circuit of claim 7, further comprising a step up transformer circuit to drive the diodes.

9. The circuit of claim 1, wherein the signal bursts from the receiver station are generated by spreading a single carrier signal over a wide band.

10. A communication system comprising:
a transmitter to transmit a re-occurring series of signal bursts at a transmit frequency;
a wireless microphone circuit to capture the transmitted signal bursts, modulate the captured signal, and transmit the modulated signal, wherein the wireless microphone circuit receives energy needed to operate solely via the captured signal bursts independent of a local power supply; and
a receiver to receive the modulated signal.

11. The system of claim 10, wherein the wireless microphone circuit comprises a resonant circuit tuned to a transmit frequency of the transmitter.

12. The system of claim 11, wherein the resonant circuit modulates the captured signal through a change in capacitance of a capacitive microphone element.

13. The system of claim 12, wherein the capacitance of the capacitive microphone element changes as a function of sound pressure within a proximity of the microphone.

14. The system of claim 11, wherein the resonant circuit modulates the captured signal by altering the resonant frequency of the resonant circuit.

15. The circuit of claim 10, wherein the receiver is tuned to the frequency of the signal transmitted by the wireless microphone circuit.

16. The circuit of claim 10, wherein the wireless microphone circuit comprises two diodes, the diodes to create a second harmonic of modulated signal prior to transmission.

17. A method comprising:
transmitting a re-occurring series of signal bursts at a transmit frequency;
capturing and modulating the transmitted signal bursts prior to transmission, wherein the capture, modulation and transmission are conducted a wireless microphone circuit receives energy needed to operate solely via the captured signal bursts independent of a local power supply; and
receiving the modulated signal.

18. The method of claim 17, wherein the wireless microphone circuit comprises a resonant circuit to modulate the captured signal through a change in capacitance of a capacitive microphone element in the resonant circuit.

19. A communication system comprising:
a remote control comprising a wireless microphone circuit, comprising:
a resonant circuit tuned to a transmit frequency of a receiver station, the resonant circuit to capture signal bursts from the receiver station, the resonant circuit to modulate the captured signal; and
a transmitter circuit to transmit the modulated signal, wherein the resonant circuit receives energy needed to operate the resonant circuit solely via the captured signal bursts independent of a local power supply; and
a set top box comprising the receiver station.

20. The system of claim 19, wherein the resonant circuit modulates the captured signal through a change in capacitance of a capacitive microphone element.
